(19) United States
(12) Patent Application Publication
(10) Pub. No.: US 2016/0112405 A1
(43) Pub. Date: Apr. 21, 2016

(54) System, Network Terminal, Browser And Method For Displaying The Relevant Information Of Accessed Website

(71) Applicants: Beijing Qihoo Technology Company Limited, Beijing (CN); Qizhi Softwarre (Beijing) Company Limited, Beijing (CN)

(72) Inventors: Zhenke HE, Beijing (CN); Wu ZHAO, Beijing (CN); Dongmiao HUANG, Beijing (CN)

(21) Appl. No.: 14/436,703

(22) PCT Filed: Oct. 10, 2013
(86) PCT No.: PCT/CN2013/084996

§ 371 Date: Apr. 17, 2015

(30) Foreign Application Priority Data
Oct. 17, 2012 (CN) 201210395504.9

(51) Int. Cl. H04L 29/06; H04L 29/08

(52) U.S. Cl. CPC H04L 63/0823; H04L 63/1425; H04L 67/02

(57) ABSTRACT

A method, browser, network device and system for presenting relevant information of accessed website are disclosed in the present disclosure. The method comprises the following steps: receiving the website address of the accessed website at the browser; requesting a security detecting device to detect the website address; receiving the detecting result returned from the security detecting device; when the website address is indicated to be a malicious website address by the detecting result, displaying a prompt message that the accessed website is a malicious website at the browser; and when the website address is indicated to be an un-malicious website address by the detecting result, obtaining the website certification information of the accessed website from a first server, and displaying the obtained website certification information at the browser. The technical solution of the present disclosure can solve the problem that, if a remote server had not been updated in time, the website would be displayed as a safe website even if the accessed website has a virus. A beneficial effect of higher veracity in security detecting of the accessed website is achieved.

### TECHNICAL FIELD

The invention relates to the field of computer networks, particularly to a method, browser, network device and system for presenting relevant information of an accessed website.

### BACKGROUND ART

With rapid development of the Internet, there are more and more users in the Internet, who usually connect to the Internet by means of various terminals. An increasing number of applications are provided on the Internet, and the core applications such as online shopping, online banking, and the like are also started to be widely used by Internet users.

Malicious softwares like trojan horse and virus exists in the Internet and intrudes into the user terminals to gain improper profits. At present, most attacks to the terminals of internet users are originated from the network transmitted virus, and websites usually become the “carrier” for transmitting the virus. In addition, procedural loopholes on some real web servers are taken advantage of, virus codes are inserted into some web pages of the website, so as to cheat users out of their private information such as account number and password of the bank or credit card.

In order to resist the websites with virus or defects and prevent the Internet users from loss, prior art adopts the way of informing a remote server of the accessed website and the remote server feeding back the relevant information of the website, and informs the users of the safe website.

However, the confirmation of the security of the website relies only on the remote server. If a remote server had not been updated in time, an accessed website would be displayed as a safe website even if the accessed website has a virus. Thus, users could not be effectively prevented from accessing malicious websites.

### SUMMARY OF THE INVENTION

In view of aforesaid problem, the present disclosure is put forward to provide a method, browser, and system for presenting relevant information of an accessed website at the browser to overcome aforesaid problem or at least partly solve aforesaid problem.

According to one aspect of the present disclosure, a method for presenting relevant information of an accessed website is provided, comprising:

receiving the website address of an accessed website at the browser; requesting a security detecting device to detect the website address; receiving the detecting result returned from the security detecting device;

when the website address is indicated to be a malicious website address by the detecting result, displaying a prompt message that the accessed website is a malicious website at the browser; and

when the website address is indicated to be an un-malicious website address by the detecting result, obtaining the website certification information of the accessed website from a first server, and displaying the obtained website certification information at the browser.

Optionally, the step of obtaining the website certification information of the accessed website from the first server comprises:

sending information on the root domain name in the website address of the accessed website to the first server;

obtaining a certification type corresponding to the root domain name from the first server, the website certification information comprising the obtained certification type, wherein the certification type comprises at least one of the following types: safe website certification and Internet Content Provider Registration Record website certification.

Optionally, the steps further comprise:

after displaying the obtained website certification information;

receiving the instruction of presenting the website card of the accessed web site, obtaining the website card of the accessed website from a second server and displaying the obtained website card;

the website card is used for presenting website identity information, and comprises at least one of the following information: website name, website address, website type, sponsor name of website, sponsor type of website, registration certificate number, license certificate number and identification of passing security checking.

Optionally, the step of obtaining the website card of the accessed website from the second server comprises:

sending website card requesting information to the second server, the website card requesting information comprising the information on the root domain name in the website address and the certification type of the website.

According to one aspect of the present disclosure, a browser for presenting relevant information of an accessed website is provided, and the browser comprises:

a user interface, configured to receive the website address of the accessed website, and transmit the website address to a website detecting module;

the website detecting module, configured to request a security detecting device to detect the website address and receive the detecting result returned from the security detecting device;

a certification information presenting module, coupled to the website detecting module; configured to obtain the website certification information of the accessed website from a first server, and present the obtained website certification information, when the website address is indicated to be an un-malicious website address by the detecting result;

a prompt displaying module, coupled to the website detecting module; configured to display a prompt message that the accessed website is a malicious website when the website address is indicated to be a malicious website address by the detecting result.

Optionally, the certification information presenting module further comprises:

a certification type acquisition unit, configured to send information on the root domain name in the website address of the accessed website to the first server; obtain a certification type corresponding to the root domain name from the first server, the website certification information comprising the obtained certification type, wherein the certification type comprises at least one of the following types: safe website certification and Internet Content Provider Registration Record website certification; and

a certification type displaying unit, configured to display the obtained certification type.

Optionally, the certification information presenting module further comprises: a card acquisition unit, configured to obtain the website card of the website from the second server and display the obtained website card;

the website card is used for presenting website identity information, and comprises at least one of the following information: website name, website address, website type, sponsor name of website, sponsor type of website, registration certificate number, license certificate number and identification of passing security checking.

Optionally, the card acquisition unit is configured to:

send website card requesting information to the second server, the website card requesting information comprising the information on the root domain name in the website address and the certification type of the website.

According to one aspect of the present disclosure, a network device for presenting relevant information of an accessed website is provided, and the network device comprises:

a security detecting device and any one of the abovementioned browsers;

a security detecting device, configured to detect whether a website address from the browser is malicious website address and feed back the detecting result to the browser.

According to one aspect of the present disclosure, a system for presenting relevant information of an accessed website is provided, and the system comprises:

one or more network devices, each network device comprising:

any one of the abovementioned browsers,

a security detecting device, configured to detect whether a website address from the browser is malicious website address and feed back the detecting result to the browser, and

a first server, configured to inquire the certification information of the web site received from the browser, and return the website certification information to the browser.

Optionally, the system further comprises:

a second server, configured to obtain the website card of the accessed website received from the browser, and return the website card to the browser.

According to the disclosure, receiving the website address of the accessed website, requesting a security detecting device to detect the website address and receiving the detecting result returned from the security detecting device, so that a professional security detecting device can be used to detect the accessed website, thus the present disclosure solve the problem that, if a remote server had not been updated in time, the website would be displayed as a safe website even if the accessed web site has a virus. And a beneficial effect of higher veracity in security detecting of the accessed website is achieved.

According to the disclosure, when an accessed website address is indicated to be a malicious website address by the detecting result, a prompt message that the accessed website is a malicious website is displayed, because the information of the malicious website is highlighted, the users' attention is improved to keep users from overlooking the security information of the accessed website for the security information of the accessed website is only displayed in partial area of the browser.

Above description is only a summary of the technical solution of the present disclosure. To make the understanding of the technical means of the present disclosure clearer, they can be put into practice according to the content of the description, and to make the aforesaid and other purpose, features and advantages of the invention clearer, the embodiments of the invention will be described in further detail.

### BRIEF DESCRIPTION OF THE DRAWINGS

By reading the detailed description of the preferably selected embodiments below, various other advantages and benefits become clear for a person of ordinary skill in the art. The drawings are only used for showing the purpose of preferred embodiments and are not intended to limit the present disclosure. And in the whole drawings, same drawing reference signs are used for representing the same components. In the drawings:

FIG. 1 is a structural diagram showing a system for presenting relevant information of an accessed website according to an embodiment of the invention.

FIG. 2 is a structural diagram showing a system for presenting relevant information of an accessed website in a specific application scenario according to an embodiment of the invention.

FIG. 3 is an interface presenting a prompt message that the accessed website is a malicious website according to an embodiment of the invention.

FIG. 4 is an interface presenting the certification type and website card of a safe website according to an embodiment of the invention.

FIG. 5 is an interface presenting the certification type and website card of the ICP registration record website according to an embodiment of the invention.

FIG. 6 is an interface presenting a prompt message that the certification type of the accessed website is not obtained according to an embodiment of the invention.

FIG. 7 is a flowchart showing a method for presenting relevant information of an accessed website according to an embodiment of the invention.

FIG. 8 is a flowchart showing a method for presenting relevant information of an accessed website in a specific application scenario according to an embodiment of the invention.

### DETAILED DESCRIPTION OF THE INVENTION

The embodiments of the present disclosure are described in further detail with reference to the drawings hereinafter. Although the drawings show the exemplary embodiments disclosed herein, it should be understood that the disclosure can be implemented in various forms and is not intended to be limited by the embodiments described here. On the contrary, the embodiments are provided to make the invention understood more thoroughly and completely convey the scope of the disclosure to a person skilled in the art.

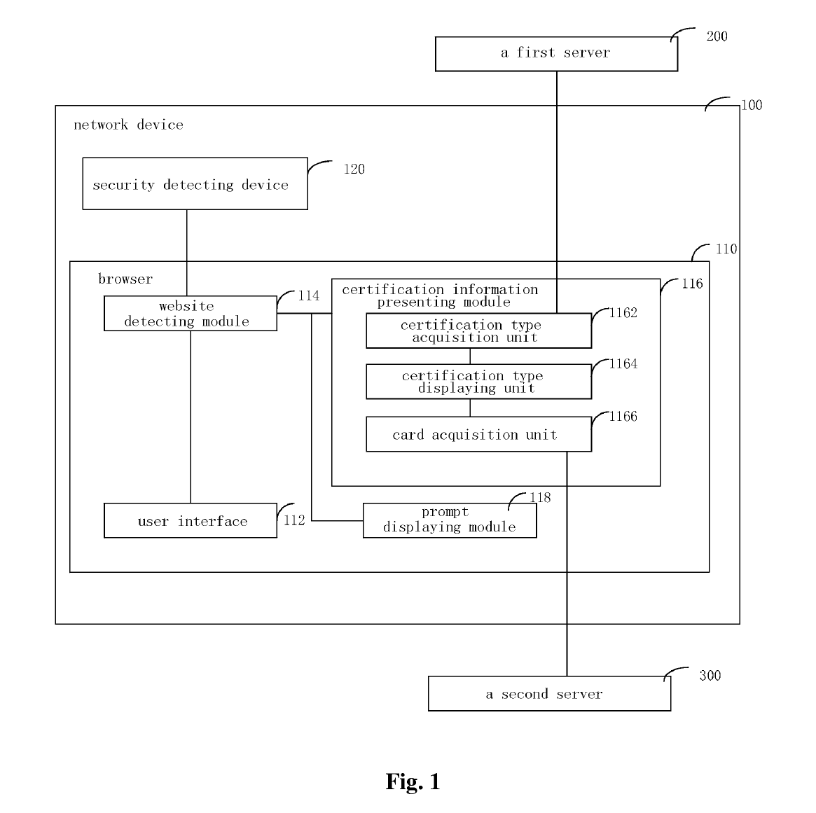

FIG. 1 is a structural diagram showing a system for presenting relevant information of an accessed website according to an embodiment of the invention.

The system comprises one or more network devices 100, a first server 200 and a second server 300. Each network device 100 comprises: a browser 110 and a security detecting device 120.

The security detecting device 120 is configured to detect whether a website address from the browser 110 is a malicious website address and feed back the detecting result to the browser 110.

The browser 110 comprises a user interface 112, a website detecting module 114, a certification information presenting module 116 and a prompt displaying module 118. The certification information presenting module 116 specifically comprises: a certification type acquisition unit 1162, a certification type displaying unit 1164 and a card acquisition unit 1166.

The user interface 112 is configured to receive the website address of the accessed website, and transmit the received website address to the website detecting module 114.

The website detecting module 114 is coupled to the security detecting device 120 at the network device where the browser 110 locates at, is configured to request the security detecting device 120 to detect the website address received from the user interface 112; and receive the detecting result returned from the security detecting device 120 and transmit the detecting result to the certification information presenting module 116 and the prompt displaying module 118.

Thus, the security detecting device 120 is used for detecting. For example, the security detecting device 120 can be a network shield module in a device, the security detecting device 120 is located in the network device 100 and is separated from the browser 110. The security detecting device 120 can update the virus library relatively independently and can accomplish the security detecting of the website address from the website detecting module 114 relatively independently. In this way, before judging various certification information of the website, the security of the content in the web page corresponding to the website address can be prechecked, and thus the security of the system is enhanced. In addition, the security detecting device 120 residing on the network device 100 can be provided by a specialized security software provider, so that the virus library in the security detecting device 120 can be updated more timely, and thus higher veracity in security detecting of the accessed website is achieved.

The prompt displaying module 118 is coupled to the website detecting module 114, when the website address is indicated to be a malicious website address by the detecting result, displaying a prompt message that the accessed website is a malicious website.

Thus the information of malicious website is highlighted, and users' attention is improved to keep users from overlooking the prompt message because the prompt message of the malicious website is only displayed in partial area of the browser 100, and leading to logging in the malicious website by mistake.

The certification information presenting module 116 is coupled to the website detecting module 114, when the accesses website address is indicated to be an un-malicious website address by the detecting result from the website detecting module 114, obtaining the website certification information of the accessed website from the first server 200, and presenting the obtained website certification information.

Thus, when the accessed website is a malicious website address, the waste of network resource caused by the failure of requesting the first server 200 to obtain the website certification information of the accessed website can be avoided. The website certification information is obtained only when the accessed website address is indicated to be an un-malicious website address by the detecting result, thus, the network resource can be saved effectively.

For example, the web site certification information comprises the certification type, wherein the certification type comprises at least one of the following types: safe website certification and ICP (Internet Content Provider) registration record website certification.

In the certification information presenting module 116, the certification type acquisition unit 1162 is configured to send information on the root domain name in the website address of the accessed website to the first server 200. After the first server 200 receives the information on the root domain name in the website address of the accessed website, it will search the certification type according to the information on the root domain name and then return the certification type. Afterwards, the certification type inquired is displayed by the certification type displaying unit 1164.

Thus, enables users to confirm brief security information of the accessed website by the obtained certification type and make it convenient for users to estimate the security credibility of the website.

In addition, the certification information presenting module 116 further comprises a card acquisition unit 1166, configured to obtain the website card of the website from the second server 300 and display the obtained website card.

The website card is used for presenting website identity information, and comprises at least one of the following information: website name, website address, website type, sponsor name of website, sponsor type of website, registration certificate number, license certificate number and identification of passing security checking.

For example, the card acquisition unit 1166 sends website card requesting information to the second server 300. The website card requesting information comprises information on the root domain name in the website address and the certification type of the website. The information on the root domain name in the website address comprises the hash value of the root domain name. The second server 300 obtains the root domain name according to the hash value, inquires the relevant database according to the root domain name and obtains the website card of the accessed website.

After obtaining the certification type of the website, if the certification information of the website in further detail is needed to be acquired, the website card can be obtained from the second server 300 by means of the card acquisition unit 1166. Compared with directly obtaining the website card from the second server 300 every time to display, since user's demand can be satisfied by certification type alone and the website card is not required to be further obtained in most cases, according to the embodiments, only when users need to be informed of the detailed security information of the website, the website card is requested to be obtained, thus the network resource can be saved in most cases.

The aforesaid structure that the certification information presenting module 116 comprises a certification type acquisition unit 1162, a certification type displaying unit 1164 and a card acquisition unit 1166 is an optional implementation model. The present disclosure is not limited to this. Particularly, the card acquisition unit 1166 is an optional unit. When the website card is needed to be provided, the card acquisition unit 1166 is chosen to be added into the certification information presenting module 116 besides the certification type acquisition unit 1162 and the certification type displaying unit 1164. When the website card is not needed to be provided, the certification information presenting module 116 can merely comprises the certification type acquisition unit 1162 and the certification type displaying unit 1164.

The aforesaid structure that the system comprises a network device 100, a first server 200 and a second server 300 is an optional implementation model. The present disclosure is not limited to this. Particularly, the second server 300 is an optional device. When the website card is needed to be provided, the second server 300 is chosen to be added into the system besides the network device 100 and the first server 200. When the website card is not needed to be provided, the system can merely comprise the network device 100 and the first server 200.

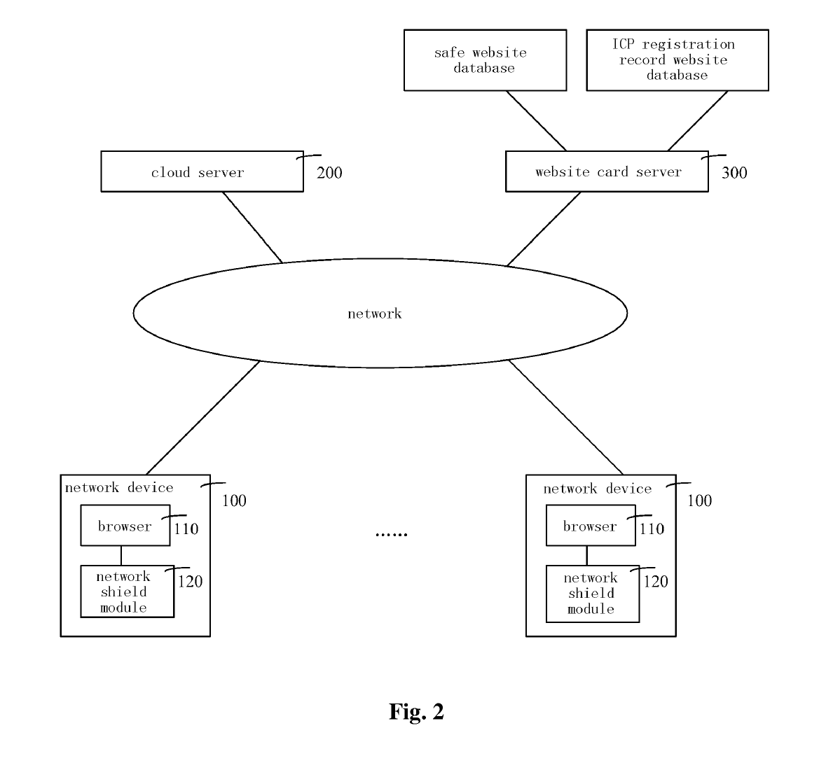

FIG. 2 is a structural diagram showing a system for presenting relevant information of an accessed website in a specific application scenario according to an embodiment of the invention. In the embodiment, the first serve is a cloud server; the second serve is a website card server; and the network device comprises a security detecting device and a browser. In the specific application scenario of the embodiment, the security detecting device is a client of network shield. The website card server is connected to the safe website database and the ICP registration record website database. The safe website database stores the website cards of safe websites and the ICP registration record website database stores the website cards of ICP registration record websites.

The browser is the browser shown in FIG. 1, wherein the user interface 112 is the address bar of the browser in the embodiment, receiving the website address of the accessed website input by users, such as URL, and transmitting the website address to the website detecting module 114.

The website detecting module 114 is configured to transmit the website address to the security detecting device 120 to perform security detecting. When the accessed website address is indicated to be a malicious website address by a detecting result, the prompt displaying module 118 is instructed to display the prompt message. When the accessed website address is indicated to be an un-malicious website address by the detecting result, the root domain name of the accessed website address is obtained and transmitted to the certification information presenting module 116. The certification information presenting module 116 is instructed to display the certification information.

The security detecting device 120 is a client of network shield, receiving the website address sent by the website detecting module 114, performing virus searching detection on the content in the web page of the accessed website according to the website address, and returning the detecting result to the website detecting module 114.

The prompt displaying module 118 is coupled to the website detecting module 114, when the accessed website address is indicated to be a malicious website address by the detecting result, displaying a prompt message that the accessed website is a malicious website. For example, as shown in FIG. 3, a warning page is popped up suggesting users not to continue to access the website. The page can be red for the purpose of highlighting.

The certification type acquisition unit 1162 is coupled to the website detecting module 114, when the accessed website address is indicated to be an un-malicious website address by the detecting result, performing MD5 operation on the received root domain name and sending a request including the MD5value of the root domain name to the cloud server 200 to inquire the certification type; receiving the inquiring result of the cloud server 200 and transmitting the inquiring result to the certification type displaying unit 1164 to display the certification type. The certification type comprises safe website certification and ICP registration record website certification.

The certification type displaying unit 1164 is configured to display the certification type according to the received inquiring result.

The cloud server 200 is configured to inquire according to the MD5 value of the root domain name of the accessed website, obtain the certification type of the accessed website, and return the obtained certification type to the certification type acquisition unit 1162.

For example, when the cloud server 200 returns the certification type information of ICP registration record website, the inquiring result is shown as follows:

{icp.info:{d: root domain name of the website}{t: website type in icp registration record}{v: version number}{p: matching rule}}.

Wherein, icp.info represents that the returned information is the certification information of ICP registration record website.

When the cloud server 200 returns the certification type information of the safe website, the inquiring result is shown as follows:

{kx.info:{d: root domain name of the website}{n: name of the website}{t: website type in safe website certification}{pr: grade of the website}{v: version number}{p: matching rule}}

Wherein, kx.info represents that the returned information is the certification information of safe website.

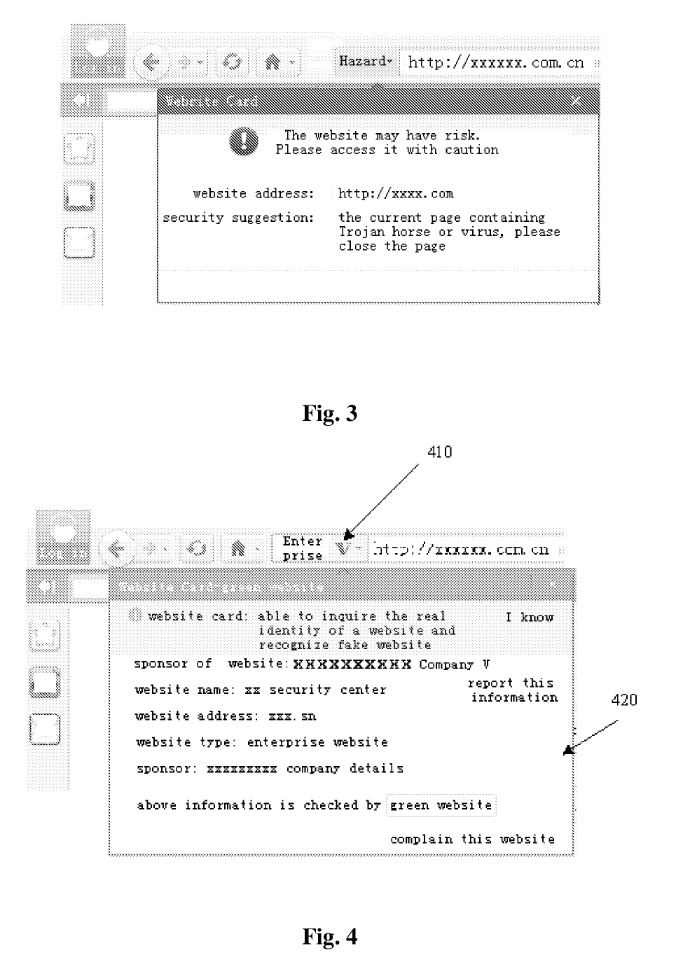

If the certification information of safe website is analyzed from the inquiring result, the certification type displaying unit 1164 will display the identification of safe website certification 410 in front of the address bar of the browser. For example, displaying the website type and adding “V” in front of the address bar to represent the safe website certification, as the “enterprise V” shown in FIG. 4, the identification is the identification of safe website certification 410. In order to be distinguished easily, the identification can be displayed in green, wherein “enterprise” is a website type, i.e. the information value in the field {t: website type in safe website certification}.

If the certification information of ICP registration record website is analyzed from the inquiring results, the certification type displaying unit 1164 will display the identification of ICP registration record website certification 510 in front of the address bar of the browser. For example, displaying the website type in front of the address bar but not adding “V” to represent the ICP registration record website certification, as the “government” shown in FIG. 5, the identification is the identification of ICP registration record website certification 510, wherein “government” is a website type, i.e. the information value in the field {t: website type in icp registration record}. In order to be distinguished easily, the identification can be displayed in blue.

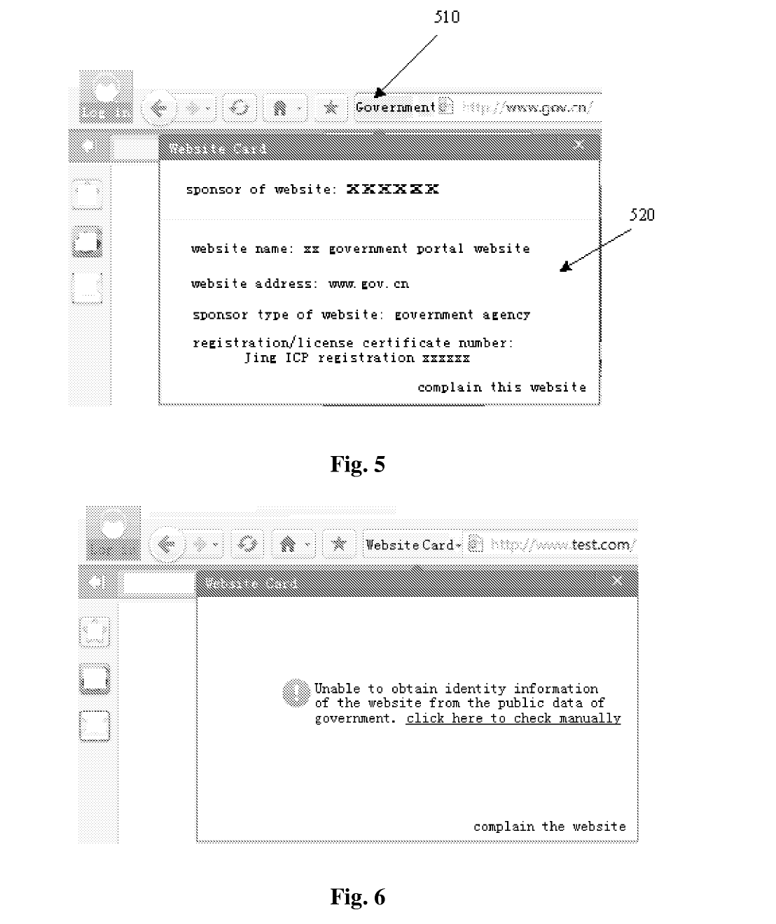

If neither the certification information of ICP registration record website nor the certification information of safe website is analyzed from the inquiring result, the certification type displaying unit 1164 will display a prompt message that no public ICP information is obtained, as is shown in FIG. 6.

Optionally, when the certification type of the accessed website is not obtained from the cloud server, the certification type displaying unit 1164 will send the website address of the accessed website to the website card server 300, so that the website card server 300 can perform statistics.

The card acquisition unit 1166 is configured to receive the instruction of presenting the website card of the accessed website, send the website card requesting information to the website card server 300, obtain the website card returned from the website card server 300 and display the website card. The website card requesting information comprises the MD5 value of the root domain name in the website address and the certification type of the website. The website card is used for presenting website identity information, and comprises at least one of the following information: website name, website address, website type, sponsor name of website, sponsor type of website, registration certificate number, license certificate number and identification of passing security checking.

As shown in FIG. 4 and FIG. 5, after user clicking the identification of safe website certification 410 “enterprise V” or the identification of ICP registration record website certification 510 “government”, the card acquisition unit 1166 will send the website card requesting information to the website card server 300.

The website card server 300 is configured to analyze the certification type of the website according to the MD5 value of the root domain name, if the certification type is ICP registration record website certification, inquire in the ICP registration record website database according to the root domain name and obtain the website card; if the certification type is safe website certification, inquire in the safe website database according to the root domain name and obtain the website card; and return the inquired website card to the card acquisition unit 1166.

The card acquisition unit 1166 obtains the website card and performs displaying, and the displaying result is, for example, the website card 420 of safe website as shown in FIG. 4 and the website card 520 of ICP registration record website as shown in FIG. 5. Classifying the website cards of the websites of different certification types makes it convenient to quickly search according to website type, and thus increases the speed of inquiring the website cards.

The foregoing descriptions are merely the exemplary illustration of the browser and system for displaying relevant information of an accessed website in the present disclosure and are not intended to limit the present disclosure. Any modification, equivalent replacement and improvement made within the spirit and principle of the present disclosure shall fall into the protection scope of the present disclosure.

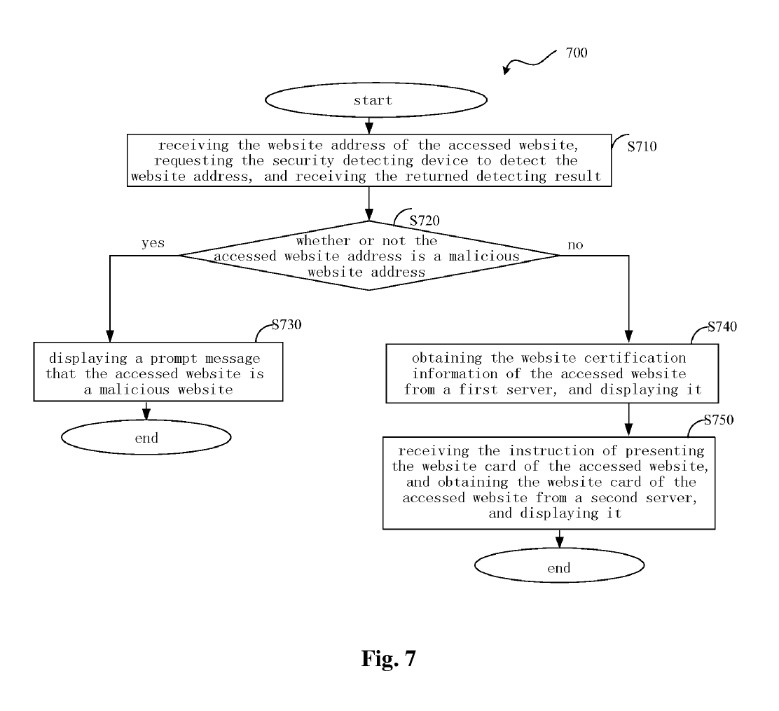

FIG. 7 is a flowchart showing the method 700 for displaying relevant information of an accessed website at a browser according to an embodiment of the invention. The method starts from step S710, wherein receiving the website address of the accessed website, requesting the security detecting device to detect the website address, and receiving the detecting result returned from the security detecting device. Generally speaking, the browser and the security detecting device are in the same network device and the security detecting device is separated from the browser. The security detecting device can update the virus library relatively independently and can accomplish the security detecting of the website address relatively independently. In this way, before judging various certification information of the website, the security of the content in the web page corresponding to the website address can be prechecked, and thus the security of the system is enhanced. In addition, the security detecting device residing on the network device can be provided by a specialized security software provider, so that the virus library in the security detecting device can be updated more timely, and thus higher veracity in security detecting of the accessed website is achieved.

Afterwards, in step S720, determining whether the detecting result obtained by step S710 indicates the accessed website address to be a malicious website address. If the detecting result indicates the accessed website address to be a malicious website address, proceeds with step S730, wherein displays a prompt message that the accessed website is a malicious website. If the determination result in step S720 is that the detecting result indicates the accessed website address to be an un-malicious website address, proceeds with step S740.

In step S740, obtaining the website certification information of the accessed website from the first server, and displaying the obtained website certification information. The website certification information comprises the obtained certification type, wherein the certification type comprises at least one of the following types: safe website certification and ICP registration record website certification.

For example, one implementation model of step S740 comprises: sending the information on the root domain name in the website address of the accessed website to the first server; obtaining the certification type corresponding to the root domain name from the first server. Wherein the information on the root domain name in the website address comprises the hash value of the root domain name.

After displaying the obtained website certification information in step S740, if users give instruction of further obtaining detailed information of the website, such as the website card of the website, proceeds with step S750 of the method. In step S750, the instruction of presenting the website card of the accessed website is received. The website card of the website is obtained from the second server. And the obtained website card is displayed. The website card is used for presenting website identity information, and comprises at least one of the following information: website name, website address, website type, sponsor name of website, sponsor type of website, registration certificate number, license certificate number and identification of passing security checking.

For example, the specific implementation mode of step S750 comprises sending website card requesting information to the second server. The website card requesting information comprises the information on the root domain name in the website address and the certification type of the website. In a similar way, optionally, the information on the root domain name in the website address can comprise the hash value of the root domain name.

The forgoing steps are only one embodiment of the method for presenting relevant information of an accessed website at the browser in the disclosure, and the method in the disclosure can be implemented by other modes. Particularly, step S750 is an optional step. When users need the website card, the website card can be obtained through step S750. When the website card is not required to be provided, the method in the disclosure can exclude step S750.

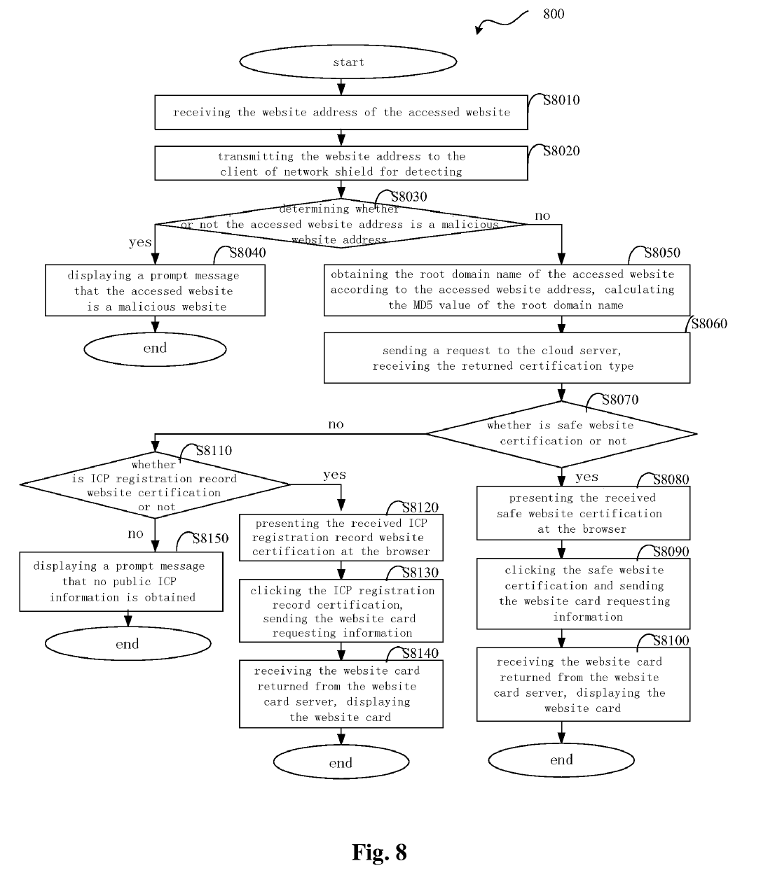

FIG. 8 is a flowchart showing a method 800 for presenting relevant information of an accessed website at a browser in a specific application scenario according to an embodiment of the invention. The method can be carried out in the above system as shown in the FIG. 2. The method 800 starts from step S8010, wherein receiving the website address of the accessed website, and then proceeds with step S8020, transmitting the website address to the client of network shield for detecting.

Afterwards, proceeds with step S8030, determining whether the accessed website address is a malicious website address according to the detecting result in step S8020. If the accessed website address is a malicious website address, proceeds with step S8040, wherein displaying a prompt message that the accessed website is a malicious website. For example, the prompt message displayed is shown in FIG. 3, a warning page is popped up suggesting users not to continue to access the website. The page can be red for the purpose of highlighting. If the accessed website address is not a malicious website address, proceeds with step S8050.

In step S8050, obtaining the root domain name of the accessed website according to the accessed website address, and calculating the MD5 value of the root domain name. Then proceeds with step S8060, sending a request for obtaining the website certification type comprising the MD5 value of the root domain name to the cloud server and receiving the certification type returned from the cloud server. The certification type comprises: safe website certification and ICP registration record website certification. For example, when the cloud server returns the certification type information of ICP registration record website, the result is shown as follows:

{icp.info :{d: root domain name of the website}{t: website type in icp registration record}{v: version number}{p: matching rule}}.

Wherein, icp.info represents that the returned information is the certification information of ICP registration record website.

When the cloud server 200 returns the certification type information of a safe website, the result is shown as follows:

{kx.info :{d: root domain name of the website}{n: name of the website}{t: website type in safe website certification}{pr: grade of the website}{v: version number}{p: matching rule}}

Wherein, kx.info represents that the returned information is the certification information of safe website.

After receiving the certification type returned from the cloud server in step S8060, proceeds with step S8070, wherein determining whether the certification type received in step S8060 is safe website certification, i.e. determining whether the returned information contains the certification information of a safe website. If it is safe website certification, proceeds with step S8080. If it is not safe website certification, proceeds with step S8110.

In step S8080, the received safe website certification is presented at the browser. The identification of safe website certification is displayed in front of the address bar of the browser. For example, displaying the website type and adding “V” in front of the address bar to represent safe website certification, as the “enterprise V” shown in FIG. 4, the identification is the identification of safe website certification 410. In order to be distinguished easily, the identification can be displayed in green, wherein “enterprise” is the website type, i.e. the information value in the field {t: website type in safe website certification}. After the obtained security certification is displayed in step S8080, if the security certification is clicked, the method 800 will proceed with step S8090. In step S8090, the website card requesting information is sent to the website card server. The website card requesting information comprises the MD5 value of the root domain name in the website address and the certification type of the website. Afterwards, proceeds with step S8100, wherein receiving the website card returned from the website card server and displaying the website card.

As is shown in FIG. 4, after user clicking the identification of safe website certification 410 “enterprise V”, the website card requesting information is sent to the website card server. The website card server obtains the root domain name according to the MD5 value of the root domain name and analyzes that the certification type of the website is security certification, and then inquires in the corresponding safe website database according to the root domain name, obtains the website card, and returns the inquired website card. The browser receives the returned website card and displays the website card 420 of safe website.

In step S8110, determining whether the certification type received in step S8060 is ICP registration record website certification, i.e. determining whether the returned information contains the certification information of ICP registration record website. If it is ICP registration record website certification, proceeds with step S8120. If it is not ICP registration record website certification, proceeds with step S8150.

In step S8120, the received ICP registration record website certification is presented at the browser. The identification of ICP registration record website certification is displayed in front of the address bar of the browser. For example, displaying the website type but not adding “V” in front of the address bar to represent ICP registration record website certification, as the “government” shown in FIG. 5, the identification is the identification of ICP registration record website certification 510, wherein “government” is the website type, i.e. the information value in the field {t: website type in icp registration}. In order to be distinguished easily, the identification can be displayed in blue. After the obtained ICP registration record certification is displayed in step S8120, if the ICP registration record certification is clicked, the method 800 will proceeds with step S8130. In step S8130, the website card requesting information is sent to the website card server. The website card requesting information comprises the MD5 value of the root domain name in the website address and the certification type of the website. Afterwards, in step S8140, the website card returned from the website card server is received and the website card is displayed.

As is shown in FIG. 5, after user clicking the identification of ICP registration record website certification 510 “government”, the website card requesting information is sent to the website card server. The website card server obtains the root domain name according to the MD5 value of the root domain name and analyzes that the certification type of the website is ICP registration record website certification, and then inquires in the corresponding ICP registration record website database according to the root domain name, obtains the website card, and returns the inquired website card. The browser receives the returned website card, and displays the website card 520 of ICP registration record website.

In step S8150, if neither the certification information of ICP registration record website nor the certification information of safe website is analyzed from the inquiring results, a prompt message that no public ICP information is obtained will be displayed, as is shown in FIG. 6.

Optionally, when the certification type of the accessed website is not obtained from the cloud server, the website address of the accessed website will be sent to the website card server, so that the website card server can perform statistics.

Thus, classifying the website cards of the websites of different certification types is convenient for quick searching according to website type, and thus increases the speed of inquiring the website cards.

The algorithms and displays provided here are not inherently related with any specific computer, virtual system or other equipments. Various general systems can be used together with teachings based on this. On the basis of the foregoing description, it is obvious to construct a structure as required by this kind of system. In addition, the present disclosure is not directed at any specific programming language. It should be understood that various programming languages can be used for realizing the content of the invention described here, and that the forgoing description of a specific language is for disclosing the optimal embodiment of the invention.

The description provided here has illustrated a lot of specific details. However, it should be understood that the embodiments of the invention can be practiced without these specific details. In some embodiments, the well-known methods, structures and techniques are not illustrated in detail, so that the description will not be obscure to be understood.

Similarly, it should be understood that in order to make the disclosure brief and help to understand one or more of the various aspects of the invention, the various features of the invention, in the aforesaid description of illustrative embodiments of the present disclosure, are sometimes grouped into a single embodiment, drawing, or description thereof. However, the disclosed method should not be explained as reflecting the following intention: i.e. the present disclosure sought for protection claims more features than the features clearly defined in any claim. To put more precisely, as is reflected in the following claims, the aspects of the invention contains less features than all the features of a single embodiment disclosed hereinbefore. Therefore, the claims complying with a specific embodiment are explicitly incorporated into the specific embodiment, wherein every claim itself acts as an individual embodiment of the invention.

Those skilled in the art can understand that adaptive changes can be made to the modules of the devices in the embodiment and the modules can be installed in one or more devices different from the embodiment. The modules or units or elements in the embodiment can be combined into one module or unit or element, and furthermore, they can be separated into more sub-modules or sub-units or sub-elements. Except that at least some of these features and/or process or unit are exclusive to each other, any combinations can be adopted to combine all the features disclosed by the description (including the attached claims, abstract and drawings) and any method or all process of the device or unit disclosed as such. Unless there is explicit statement, every feature disclosed by the present description (including the attached claims, abstract and drawings) can be replaced by substitute feature providing the same, equivalent or similar purpose.

In addition, a person skilled in the art can understand that although some embodiments described here comprise some features instead of other features included in other embodiments, the combination of features of different embodiments are deemed as falling into the scope of the present disclosure and forming different embodiments. For example, in the following claims, any one of the embodiments sought for protection can be used in various combination modes.

The various components embodiments of the present disclosure can be realized by hardware, or realized by software modules running on one or more processors, or realized by combination thereof. A person skilled in the art should understand that microprocessor or digital signal processor (DSP) can be used for realizing some or all functions of some or all components of the devices for presenting relevant information of accessed website according to the embodiments in the present disclosure in practice. The present disclosure can also realize one part of or all devices or programs (for example, computer programs and computer program products) used for carrying out the method described here. Such programs for realizing the present disclosure can be stored in computer readable medium, or can possess one or more forms of signal. Such signals can be downloaded from the Internet website or be provided at signal carriers, or be provided in any other forms.

It should be noticed that the forgoing embodiments are intended to illustrate the present disclosure and are not for limiting this invention, and a person skilled in the art can design substitute embodiments without departing from the scope of the appended claims. In the claims, any reference marks between brackets should not be constructed as limit for the claims. The word “comprise” does not exclude elements or steps that are not listed in the claims. The word “a” or “one” before the elements does not exclude the existence of a plurality of such elements. The present disclosure can be realized by means of hardware comprising several different elements and by means of properly programmed computer. In the unit claims listing several devices, several of the devices can be embodied by a same hardware item. The use of words first, second and third does not mean any sequence. These words can be explained as name.

1. A method for presenting relevant information of an accessed website, comprising:
receiving the website address of the accessed website at the browser; requesting a security detecting device to detect the website address; receiving the detecting result returned from the security detecting device;
when the website address is indicated to be a malicious website address by the detecting result, displaying a prompt message that the accessed website is a malicious website at the browser; and
when the website address is indicated to be an un-malicious website address by the detecting result, obtaining the website certification information of the accessed website from a first server, and displaying the obtained website certification information at the browser.

2. The method according to claim 1, wherein the step of obtaining the website certification information of the accessed website from the first server comprises:
sending information on the root domain name in the website address of the accessed website to the first server;
obtaining a certification type corresponding to the root domain name from the first server, the website certification information comprising the obtained certification type, wherein the certification type comprises at least one of the following types: safe website certification and Internet Content Provider Registration Record website certification.

3. The method according to claim 1, further comprising:
after displaying the obtained website certification information;
receiving the instruction of presenting the website card of the accessed website, obtaining the website card of the accessed website from a second server, and displaying the obtained website card;
the website card is used for presenting website identity information, and comprises at least one of the following information: website name, website address, website type, sponsor name of website, sponsor type of website, registration certificate number, license certificate number and identification of passing security checking.

4. The method according to claim 3, wherein the step of obtaining the website card of the accessed website from the second server comprises:
sending website card requesting information to the second server, the website card requesting information comprising the information on the root domain name in the website address and the certification type of the website.

5. A browser for presenting relevant information of an accessed website, comprising:
a user interface, configured to receive the website address of the accessed website, and transmit the website address to a website detecting module;
the website detecting module, configured to request a security detecting device to detect the website address and receive the detecting result returned from the security detecting device;
a certification information presenting module, coupled to the website detecting module, configured to obtain the website certification information of the accessed website from a first server, and present the obtained website certification information, when the website address is indicated to be an un-malicious website address by the detecting result;
a prompt displaying module, coupled to the website detecting module, configured to display a prompt message that the accessed website is a malicious website when the website address is indicated to be a malicious website address by the detecting result.

6. The browser according to claim 5, wherein the certification information presenting module further comprises:
a certification type acquisition unit, configured to send information on the root domain name in the website address of the accessed website to the first server; obtain a certification type corresponding to the root domain name from the first server, the website certification information comprising the obtained certification type, wherein the certification type comprises at least one of the following types: safe website certification and Internet Content Provider Registration Record website certification; and
a certification type displaying unit, configured to display the obtained certification type.

7. The browser according to claim 5, wherein the certification information presenting module further comprises: a card acquisition unit, configured to obtain the website card of the accessed website from a second server and display the obtained website card;
the website card is used for presenting website identity information, and comprises at least one of the following information: website name, website address, website type, sponsor name of website, sponsor type of website, registration certificate number, license certificate number and identification of passing security checking.

8. The browser according to claim 7, wherein the card acquisition unit is configured to:
send website card requesting information to the second server, the website card requesting information comprising the information on the root domain name in the website address and the certification type of the website.

9. A network device for presenting relevant information of an accessed website, comprising: a security detecting device and a browser, wherein the security detecting device is configure to detect whether a website address from the browser is a malicious website address and feed back the detecting result to the browser; and
the browser comprising:
a user interface, configured to receive the website address of the accessed website, and transmit the website address to a website detecting module;
the website detecting module, configured to request a security detecting device to detect the website address and receive the detecting result returned from the security detecting device;
a certification information presenting module, coupled to the website detecting module, configured to obtain the website certification information of the accessed website from a first server, and present the obtained website certification information, when the website address is indicated to be an un-malicious website address by the detecting result;
a prompt displaying module, coupled to the website detecting module, configured to display a prompt message that the accessed website is a malicious website when the website address is indicated to be a malicious website address by the detecting result.

10-11. (canceled)

12. The network device according to claim 9, wherein the certification information presenting module further comprises:
a certification type acquisition unit, configured to send information on the root domain name in the website address of the accessed website to the first server; obtain a certification type corresponding to the root domain name from the first server, the website certification information comprising the obtained certification type, wherein the certification type comprises at least one of the following types: safe website certification and Internet Content Provider Registration Record website certification; and
a certification type displaying unit, configured to display the obtained certification type.

13. The network device according to claim 9, wherein the certification information presenting module further comprises: a card acquisition unit, configured to obtain the website card of the accessed website from a second server and display the obtained website card;
the website card is used for presenting website identity information, and comprises at least one of the following information: website name, website address, website type, sponsor name of website, sponsor type of website, registration certificate number, license certificate number and identification of passing security checking.

14. The network device according to claim 13, wherein the card acquisition unit is configured to:
send website card requesting information to the second server, the website card requesting information comprising the information on the root domain name in the website address and the certification type of the website.
